(19) United States
(12) Patent Application Publication
(10) Pub. No.: US 2009/0277115 A1
(43) Pub. Date: Nov. 12, 2009

(54) Device and a Process for Producing Insulated Siding Panels

(76) Inventor: Roy L. Hobbie, Lawrenceburg, IN (US)

Correspondence Address: INEOS USA LLC, 3030 WARRENVILLE RD, S/650, LISLE, IL, 60532, US

(21) Appl. No.: 11/885,197

(22) PCT Filed: Jun. 1, 2006
(86) PCT No.: PCT/US06/21205

§ 371 Date: Jul. 14, 2009

Related U.S. Application Data
(60) Provisional application No. 60/687,752, filed on Jun. 6, 2005.

(30) Foreign Application Priority Data
Sep. 15, 2005 (US) 11/227921

(51) Int. Cl. E04F 13/075; B29C 44/38; B29C 67/20; E04C 2/20

(52) U.S. Cl. 52/309.1; 425/4 R; 264/46.6; 52/506.01

(57) ABSTRACT

An apparatus for producing insulated panels, comprising in sequence two congruous sheet fines, a former, a foaming structure, and an extrude.

### FIELD OF THE INVENTION

The invention concerns insulated siding panels and process for the manufacture of insulated siding panels, and more particularly siding panels that are foamed in place with insulating material.

### BACKGROUND OF THE INVENTION

The production of vinyl siding or other laminated panels that are combined with insulating materials is well-known. In principle, the exterior of the panel is a siding profile and forms a protective weather resistant surface for use on the exterior of buildings. The siding profile may be PVC or other plastic resins. Further, the interior of the panel is formed by an insulating material. The insulating material may be PU foams. The insulating material is adhered to the siding profile with an adhesive.

In securing the siding profile to the insulating material, several draw backs exists, including adhesion. PVC resins do not possess good adhesive properties to PU foams without a preconditioning of the surface for example, Corona etching). An alternate option is use of hot glue to adhere PVC resins to expandable polystyrene (EPS) or polystyrene (PS) foams. Although various adhesives may be selected with properties for use with both vinyl and insulating materials, the current vinyl siding or other laminated panels requires the hot glue adhesive and process to attach the insulating material to the siding profile. The insulating material is an EPS, PU or PS foam and the siding profile is PVC resin. The hot glue is distributed to select areas between the insulating material and the back side of the siding profile. The siding profile is attached to the foam only where there is glue.

The inventors of the present invention recognized that there are undesirable effects that result from the placement of glue between the insulating material and siding profile. For example, the glued insulating material to siding profile results in air pocket formation where moisture may collect, even though the permeability of the foam is recognized. Further, when wind blows against the glued insulated siding panels, undesirable noise may occur as the foam backing shifts because its attachment to the panel is not securely maintained.

The present invention provides improvements for insulated siding panels as compared to typical vinyl siding panels. The present invention provides an insulating material application and product that results in a more secure attachment between the insulating foam and the siding profile.

### SUMMARY OF THE INVENTION

One aspect of the present invention is to provide an insulated resin siding in which the adhesion of the external resin panel and an insulation material is foamed in place and produces an improved rigidity, durability and decreased size.

Another aspect is to provide a process for producing an insulated resin siding with an improved shape to the profile of the siding panel.

### BRIEF DESCRIPTION OF THE DRAWINGS

FIG. 1 is a block diagram of a process for producing the resin siding of the present invention;

FIG. 2 is a side view of a former for use in the process of the present invention; and

FIG. 3 is a side view of the insulated vinyl siding panels of the present invention after the pieces are cut from FIP block.

### DETAILED DESCRIPTION OF THE INVENTION

Accordingly, the invention provides an insulated siding panel and process for producing the same. The insulated siding profile of the present invention includes a siding profile formed as an exterior and an insulating panel formed as an interior. The siding profile can be made of any appropriate resin that is durable under a variety of weather conditions and temperatures, and has adhesive characteristics that are compatible with the selected insulating material. Further, the siding profile can include one or more materials and/or layers, such as a cap-stock and a substrate. The siding profile may also be extruded, co-extruded or laminated. Resins that are appropriate include for example, but not limited to, AES, ASA, PVDF, acrylic, or PVC or combinations thereof. The cap-stock layer may also be an extruded sheet layer, a laminated film layer or a combination of various film layers. The substrate may be made for strength and may include PVC or ABS.

The insulating material may be any appropriate material that has good insulating characteristics related to sound or noise. For example, polyurethane (PU) or EPS may be selected as an insulating material.

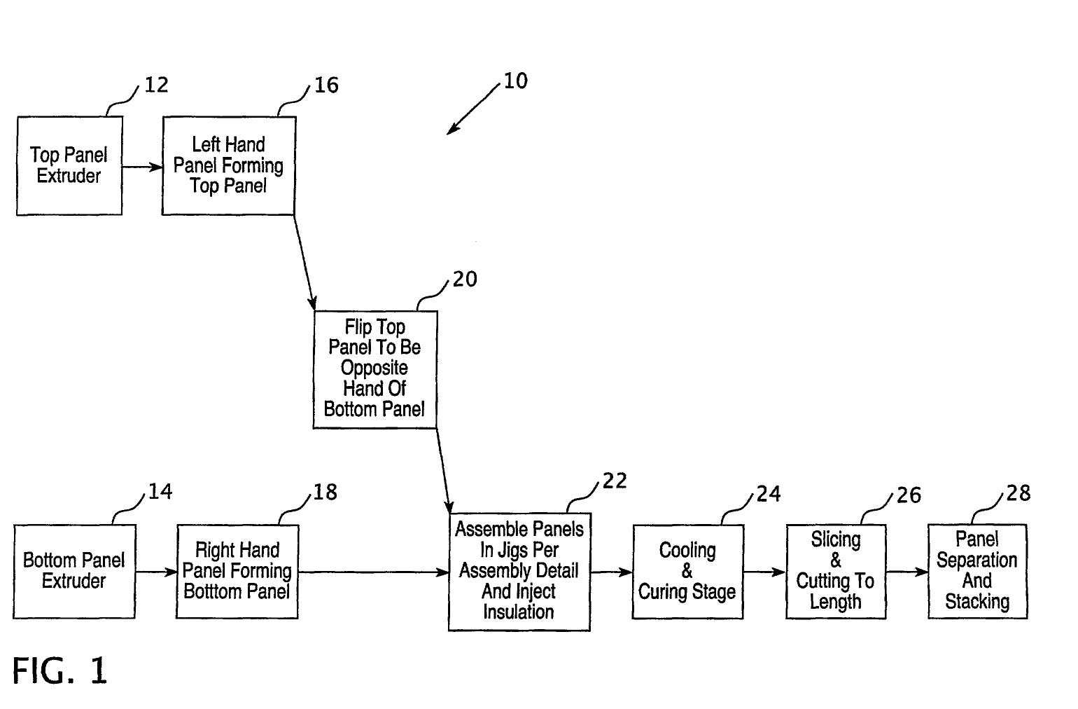

Referring to FIG. 1, a novel process 10 is provided for making the foam in place (FIP) siding or insulated siding panel of the present invention. A first profile is extruded at 12 and a second profile is extruded at 14 to each form a panel at 16 and 18, respectively. The forming of two panels at 16, 18 are oriented in a configuration such that the first panel forms a top and the second panel forms a bottom at 20.

The FIP siding is formed at 22. The top and the bottom are positioned in a jig assembly in which an insulating volume is formed between the top and bottom. The jigs are arranged to be utilized with an injection molding apparatus that provides insulating material into the volume or interior portion formed between the top and bottom panels at 22. Once the insulating material is supplied to the insulating volume, the assembly is cooled at 24. The insulation material and panels combination is cured, thereby forming a FIP block.

The FIP process provides an improved fit and more secured insulating material to the siding profile than a “cut to fit” process. In a “cut to fit” process, the shaped insulating material is formed by cutting the insulating material to the size and shape of the siding profile. Thus, the “cut to fit” product does not have a precise fit of the insulating material to the siding profile. Whereas, the present invention fits the exact profile as the insulating material is sized and shaped when attached to the siding profile.

With a more uniform fit of the insulated material to the siding profile, the insulated siding panel of the present invention has an improved impact strength as compared to the typical “hot glue” vinyl siding. The insulated siding panels have improved rigidity and strength because the entire surface of the siding profile is adhered to the insulating material. Further, the insulated siding panel provides a more rigid structure that is less prone to movement and warping under high temperature conditions. Another benefit is that for the insulating material breaking in the packaging, shipping, and installation phases is minimized. Further, the size of the insulated siding profile can be minimized and may be at a width of between 0.035 mils and 0.054 mils.

The process of forming the FIP siding may include a continuous or batch process. In a continuous process, two lines of production terminate in producing one FIP block. Two sheets are positioned in-line and with a former or extruder. A foaming device is located near the former. A cutting device is provided at the output of the former. Also with the FIP process, if continuous, may result in desired handling and energy savings.

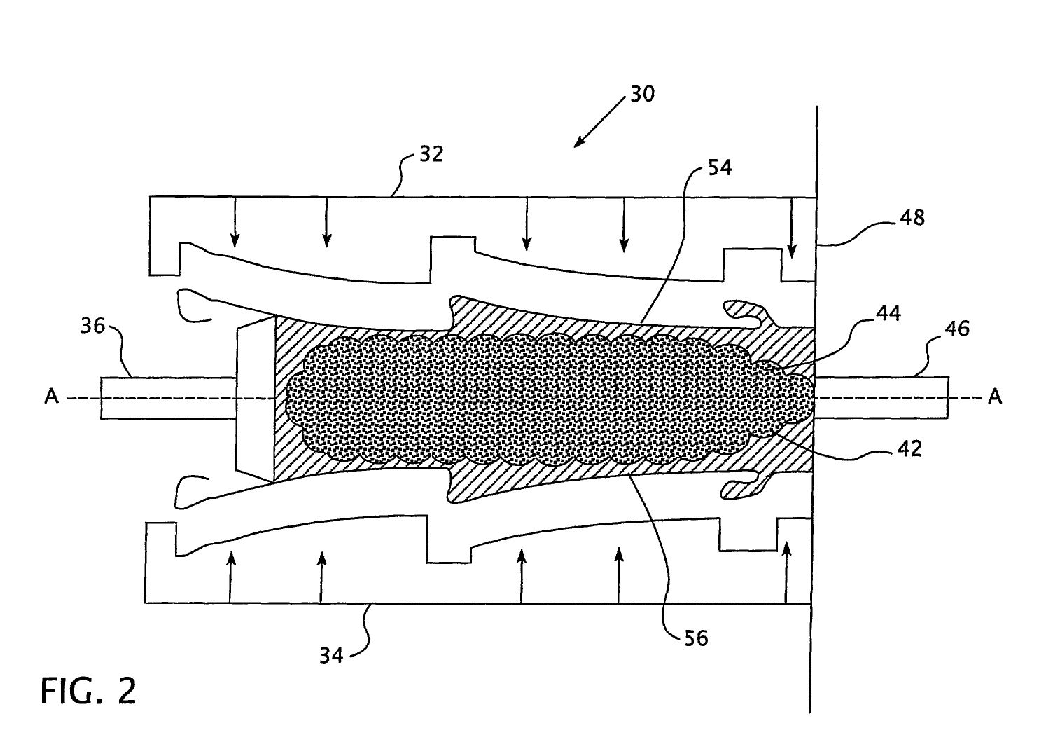

The former 22 is a chamber that forms the two siding profiles in a FIP structure. The FIP structure includes an insulating volume. The top and bottom are positioned in a jig assembly in which an insulating volume is formed between the top and bottom. The jigs are arranged to be utilized with an injection molding apparatus, and a process provides insulating material into the volume of interior position formed between the top and bottom panels at 22. FIG. 2 provides a preferred embodiment of the former. Foam or insulating material is then supplied to the volume of the FIP structure. The FIP block is then fed to a curing device that cools and cures the FIP block, thereby adhering the foam to the siding profiles at 24. The two sided FIP block is then provided to a cutting device at an orientation which causes the FIP block to be severed into two separate insulated siding panels at 26. The two pieces each are integrally formed having a first side formed of the siding profile and a second side formed by the insulating material at 28.

FIG. 2 is a former 30 used to produce the FIP siding. The sheet lines extrude resin into a former. The former receives the extruded resin and provides a shape and texture to the resin such that each produces a FIP siding panel. A top jig 32, bottom jig 34, and end jig 36 are oriented to position a first panel 38 and a second panel 40, thereby forming an insulating chamber 42 that has a volume sufficient to hold a predetermined amount of foam insulation material 44. However, the former 30 may include any appropriate jigs or supports to create a desired volume, size and shape. A foam injection nozzle 46 is placed at a position to fill the insulating chamber 42. A pinch plate 48 is provided at one portion of the insulating chamber to maintain a flat nailing surface on the volume of foam insulation material. The insulation chamber 42 is filled with the expanding foam insulation material 44. A cut line, axis A-A, is selected at a position between the first and second panel 38, 40 so that the insulation block may be severed at this line.

ABS is designed to maximize adhesion with PU foams. The substrate could be ABS and the surface cap-stock can be an ASA, AES, or UV stabilized resin or other similar resin. The resin panel may also include biocides or other materials to protect the house from environmental elements.

The present invention can include PU and PS foams. It is possible that alternate foams could be used, that are compatible with adhering to the resin of the panel.

The insulating panel may be formed from a material that provides good adhesion ability with the selected resins, for example but not limited to, ABS. Typical exterior siding profile widths are in the range of 0.040 mils to 0.054 mils. The Vinyl Siding Institution standards require a minimum of 0.035 mils for VSI certification of the product. It is possible for a minimization in resin sheet width since the PU foam adhesion is uniform, thus adding addition strength to the composite structure.

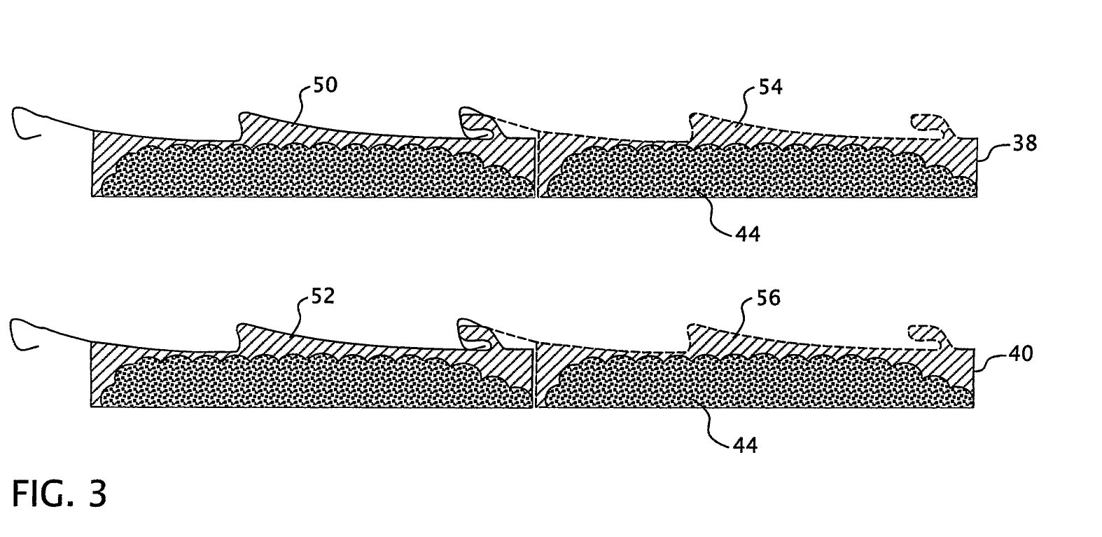

FIG. 3 illustrates separated foam siding panels, 38, 40 and 50, 52, of the present invention in a configuration for placing on a building.

Although the present invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. An apparatus for producing insulated panels, comprising:
two congruous sheet lines;
a former;
a foaming structure; and
an extruder.

2. The apparatus according to claim 1, further comprising a curing unit positioned between the foaming structure and the extruder.

3. The apparatus according to claim 1, wherein a suction device is positioned between a cooling unit and a sizing unit.

4. A process for producing a foam in place siding panel, comprising: forming two siding profiles;
arranging the two siding panels at a distance from each other; foaming an insulating material between the two siding panels, thereby forming a FIP block;
cutting the FIP block at a position parallel to the siding profiles.

5. The process for producing the foam in place siding panel of claim 4, wherein the forming, foaming and cutting is a continuous process.

6. A siding panel, comprising:
a panel siding member; and
an insulating material having a first surface and a second surface; wherein
the first surface is integrally attached to the panel siding member to form a continuously joined interface.

7. The integral panel of claim 6, wherein the insulating material is a polyurethane.

8. The integral panel of claim 6, wherein the insulating material and panel siding member are less than 0.040 mils.
